(19) United States
(12) Patent Application Publication
(10) Pub. No.: US 2024/0055681 A1
(43) Pub. Date: Feb. 15, 2024

(54) PROCESS FOR RECOVERING MATERIALS FROM SPENT RECHARGEABLE LITHIUM BATTERIES

(71) Applicant: TESLA, INC., Austin, TX (US)

(72) Inventors: Feng Zou, Mississauga (CA); Quanmin Yang, Mississauga (CA); Vladimir Paserin, Mississauga (CA); Alex Carpenter, Seabrook, TX (US)

(21) Appl. No.: 18/259,038

(22) PCT Filed: Dec. 21, 2021
(86) PCT No.: PCT/US2021/064720

§ 371 Date: Jun. 22, 2023

Related U.S. Application Data
(60) Provisional application No. 63/130,196, filed on Dec. 23, 2020.

(51) Int. Cl. H01M 10/54; C22B 7/00; C22B 23/02; C22B 23/06; C22B 26/12; C22B 3/22

(52) U.S. Cl. CPC H01M 10/54; C22B 7/002; C22B 23/021; C22B 23/028; C22B 23/065; C22B 26/12; C22B 3/22

(57) ABSTRACT

A method for recovering the valuable materials from energy storage devices (e.g., spent rechargeable lithium batteries, especially those batteries using nickel-based or nickel and cobalt containing cathode materials) are described. In particular, the proposed method applies carbonyl technology, also known as vapometallurgy, to regenerate pure materials which can be reused as raw materials for making active cathode materials for new lithium batteries.

### INCORPORATION BY REFERENCE TO ANY PRIORITY APPLICATIONS

Any and all applications for which a foreign or domestic priority claim is identified in the Application Data Sheet or Request as filed with the present application are hereby incorporated by reference under 37 CFR 1.57, and Rules 4.18 and 20.6, such as U.S. Provisional App. No. 63/130,196, filed Dec. 23, 2020.

### BACKGROUND

This invention relates to a method for recovering the valuable materials from spent rechargeable lithium batteries, especially those batteries having nickel-based cathodes. In particular, the provided method relates to regenerating essentially pure materials which can be reused as raw materials in the production of active cathode materials for new rechargeable lithium batteries.

### DESCRIPTION OF THE RELATED ART

Since their commercialization, rechargeable lithium batteries have been used in many different types of devices and equipment as an energy storage component. These include mobile-phones, portable computers, wireless power tools, hybrid and pure electric automobiles, and the like. In recent years, the demand for high output rechargeable lithium batteries has increased dramatically especially with the rapid market growth of electric vehicles (EV).

The major components in a rechargeable lithium battery include an anode, a cathode, and electrolyte. During its charge and discharge cycles, lithium ions are shuttled between the anode and cathode active materials through the electrolyte. Due to its limited specific capacity, the high cost of production and the use of expensive raw materials including lithium, nickel and cobalt, the cathode active material is usually the most expensive component in rechargeable lithium batteries. In recent years, nickel-rich, high capacity cathode materials have gained market share in those batteries destined for the EV market. This trend is expected to continue into the next decade. Considering the expected phenomenal growth in EV market and therefore the huge demand for the above cathode materials, rechargeable lithium battery production could be limited in the future by a global supply shortage of the key elements (e.g., Ni, Co, and Li), especially in volatile geopolitical situations. Hence, recycling of spent rechargeable lithium batteries to recover any or all of these key elements may help to alleviate the demand for raw materials and safeguard the supply chain of electric vehicle industry. Furthermore, spent rechargeable lithium batteries are considered as an environmental and fire hazard, and it is important that they be recycled and re-processed in order to sustain a massive EV market.

Most research and development of rechargeable lithium batteries recycling and regeneration has focused on acid leaching technologies. Generally, several major steps are involved in the process, namely: (a) discharge the spent batteries; (b) dismantle the batteries and separate battery components; (c) apply acid leach to lixiviate the desired metals and separate them with a hydrometallurgical approach; and (d) use the metals to regenerate cathode materials with traditional, incumbent industrial methods, i.e. co-precipitation of metals to generate precursors and calcination with lithium compounds to obtain the final cathode materials. Typically in such an acid process, sulphuric acid with other chemicals (e.g. such as Na₂SO₅ and Na₂SO₃), are applied in order to leach the metals in step (c). Afterwards, a solvent extraction process may be used to separate the different metals with organic extractants, such as di-2-ethylhexyl phosphoric acid (“P204”) and 2-ethylhexyl phosphoric acid mono-2-ethylhexyl ester (“P507”). However, this is a complex process with significant amounts of liquid effluent being generated, which effluent must be treated in order to minimize environmental impacts. Although solventless extraction steps for metal separation may be performed in the process, such a solventless process typically can only be applied to spent batteries having the same composition, and the purity of regenerated cathode materials is greatly reduced without solvent extraction since metal separation step is also considered as a step of purification.

In addition, because the valuable metals recovered from spent batteries using the above described acid leaching processes must be in the form of a metal salt, such as nickel sulphate and cobalt sulphate, co-precipitation process for making the precursor is normally applied to the regeneration of the cathode materials. Such co-precipitation processes typically generate significant amount of a Na₂SO₄-containing solution after removal of the solid portion with the filtration process. Because the solution contains Na₂SO₄, the collected solution cannot be reused in the reaction system and thus, must be treated as an effluent. In addition, ammonia is commonly added to the reaction system, as a chelating agent, in order to assist in providing the desired physical properties of the precursor materials. Therefore, besides the salts (such as sodium sulphate), the effluent can also contain ammonia, ammonium, dissolved heavy metals, small solid particles, and the like. Required by regulations across the globe, this effluent has to be treated to remove ammonia and sodium sulphate before it can be discharged to the environment or recycled to the reaction system. Such an effluent treatment is costly with significant amount of energy consumption. Moreover, due to the limited industrial application and demand, sodium sulphate is generally considered as a solid waste after the treatment of the effluent, and provides little or no added value.

Therefore, the current practice of acid-leaching and hydrometallurgical process for rechargeable lithium batteries recycling not only produces a large amount of liquid effluent itself, it also leads to the application of traditional cathode material production technology that generates more liquid effluent in the process. This creates a huge environmental footprint in the life cycle of EV batteries.

Although some environment friendly processes for making rechargeable lithium batteries cathode materials are known that attempt to eliminate effluent generation and therefore minimize the environmental impact and costs, such processes typically require nickel and cobalt in their metallic powder form as starting materials. However, the majority of the nickel and cobalt from spent lithium is not in metallic powder form.

It would be advantageous to provide a process for the recycling of cathode material elements from spent batteries (e.g., spent rechargeable lithium batteries) that is able to provide a more environmentally friendly, cost effective process for recovering key elements.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

As such, in a first aspect, a process to recover the valuable materials from spent rechargeable lithium batteries to pure materials, especially from those batteries using nickel-based and nickel and cobalt containing cathode materials is disclosed. The regenerated materials are suitable for, although not limited to, an effluent free process in production of cathode materials for new rechargeable lithium batteries.

In particular, one embodiment of the process preferably includes the following major steps, namely:
discharging the spent rechargeable lithium batteries in an aqueous (e.g., saline) solution;
dismantling the batteries and separating battery components;
crushing the collected electrode and separating electrode materials from other components; reducing the collected cathode electrode materials together with anode electrode materials; recovering valuable nickel and cobalt using carbonyl technology;
optionally conducting a carbonyl distillation step if the collected electrode material contains iron; and,
after removing nickel, iron (if present) and cobalt, recovering valuable lithium from the remaining electrode materials by water or acid lixiviation method.

Accordingly, the present disclosure provides a process to recover the valuable elements from spent rechargeable lithium batteries to the forms suitable for the effluent free process in reproduction of the cathode materials for new rechargeable lithium batteries.

However, it should be noted that the uses and applications for the elements recovered from the processes disclosed are not limited only to the production of cathode materials for new rechargeable lithium batteries, but these can also be used in other applications.

In one aspect, a process to recover materials from an energy storage device electrode is described. The process includes: reducing an electrode active material mixture to form a reduced mixture, wherein the electrode active material mixture comprises a nickel oxide, a cobalt oxide, and a lithium material selected from the group consisting of a lithium salt, a lithium oxide and combinations thereof; performing a first carbonylation and a subsequent first decomposition on the reduced mixture to isolate a nickel product comprising nickel metal form a first carbonylated material; and performing a second decomposition on the first carbonylated material to isolate a cobalt product comprising cobalt metal form a residue material.

In some embodiments, reducing comprises reacting the electrode active material mixture with a compound selected from the group consisting of hydrogen, a carbonaceous material, a hydrocarbon material, a partially reformed product thereof, and combinations thereof. In some embodiments, reduction is performed at temperature of about 300-1200° C. In some embodiments, the first carbonylation comprises reacting the reduced mixture with a gas selected from the group consisting of carbon monoxide, nitrogen monoxide, hydrogen, and combinations thereof. In some embodiments, the first carbonylation is performed at a temperature of about 40-120° C. In some embodiments, the first carbonylation is performed at a pressure of about 15-2000 PSIG.

In some embodiments, the process further includes distilling the reduced mixture subsequent to the first carbonylation and prior to the first decomposition thereby removing an iron product comprising an iron carbonyl from the reduced mixture. In some embodiments, the process further includes mixing an additive with the reduced mixture. In some embodiments, the additive is selected from the group consisting of a sulfur material, a tellurium material, Cl₂, LiCl, NaCl, KCl, CaCl₂, MgCl₂, and combinations thereof. In some embodiments, the additive is mixed with the reduced mixture in about 1-10 wt. % of the reduced mixture.

In some embodiments, the process further includes performing a sublimation on the first carbonylated material prior to the second decomposition. In some embodiments, the process further includes performing a second carbonylation on the first carbonylated material prior to the second decomposition. In some embodiments, the second carbonylation comprises reacting the reduced mixture with a gas comprising carbon monoxide. In some embodiments, the second carbonylation is performed at a temperature of about 40-120° C. In some embodiments, the second carbonylation is performed at a pressure of about 800-2500 PSIG. In some embodiments, the process further includes performing a distillation on the first decarboxylated material subsequent to the second carbonylation and prior to the second decomposition.

In some embodiments, the process further includes: discharging an energy storage device in an aqueous solution; dismantling the discharged energy storage device to isolate the electrode materials; and destructuring the electrode materials to form the active material mixture. In some embodiments, the aqueous solution has a conductivity of at least about 1000 mS/m. In some embodiments, the aqueous solution is a saline solution comprising a salt selected from the group consisting of Na₂SO₄, NaCl, and combinations thereof. In some embodiments, destructuring forms an active material mixture comprising particles with an average particle size of at most about 5 mm. In some embodiments, the process further includes washing the destructured electrode materials and separating the active material mixture from a current collector material. In some embodiments, washing comprises applying an organic solvent selected from the group consisting of N-methyl-2-pyrrolidone (NMP), N, N-dimethylformamide, N,N-dimethylacetamide, and combinations thereof. In some embodiments, the energy storage device is a spent lithium ion battery.

In some embodiments, the process further includes performing a lixiviation extraction to isolate a lithium product. In some embodiments, the lixiviation extraction comprises: dissolving the residue material in an aqueous solution to form a slurry; performing a solid/liquid separation on the slurry to isolate a lithium rich solution from a solid reside; and performing an isolation process on the lithium rich solution to form the lithium product. In some embodiments, the aqueous solution comprises an acid. In some embodiments, the lithium product is selected from the group consisting of lithium hydroxide, lithium carbonate, and combinations thereof.

### BRIEF DESCRIPTION OF THE DRAWINGS

FIG. 1 depicts a block diagram showing general process steps for recovering elements from a spent battery, according to one embodiment.

FIG. 2 depicts a block diagram showing carbonyl refining process steps, according to one embodiment.

FIG. 3 depicts a block diagram showing lixiviation extraction process steps, according to one embodiment.

FIG. 4 depicts a block diagram showing specific process steps for recovering elements from a spent battery, according to one embodiment.

FIG. 5A depicts thermogravimetric analyzer (TGA) results showing concentration vs. elapsed time plot of Ni(CO)₄ of exhaust gases.

FIG. 5B depicts a thermogravimetric analyzer (TGA) results showing normalized weight vs. elapsed time plot of Ni(CO)₄ of exhaust gases.

FIG. 6 depicts a thermogravimetric analyzer (TGA) results showing percent yield of total extractable metal vs. time under various hydrogenation process conditions.

FIG. 7 depicts a plot showing weight loss profiles as a function of reduction temperature, according to some embodiments.

FIG. 8A shows a powder X-ray diffraction (XRD) profiles a black mass material prior to reduction, according to some embodiments.

FIG. 8B shows a powder X-ray diffraction (XRD) profiles a black mass material subsequent to reduction, according to some embodiments.

FIG. 9A is a scanning electron microscopy (SEM) image of nickel powder collected from the disclosed process, according to some embodiments.

FIG. 9B is a scanning electron microscopy (SEM) image of nickel powder collected from the disclosed process, according to some embodiments.

FIG. 9C depicts a qualitative search/match results from powder X-ray diffraction (XRD) data of the nickel powder collected from the disclosed process, according to some embodiments. The major phase exhibits diffraction peaks consistent with face-centered cubic nickel (Fm-3m). The minor phase exhibits diffraction peaks consistent with hexagonal nickel (P6₃/mmc).

FIG. 10A is a scanning electron microscopy (SEM) image of nickel powder collected from the disclosed process, according to some embodiments.

FIG. 10B is a scanning electron microscopy (SEM) image of nickel powder collected from the disclosed process, according to some embodiments.

FIG. 10C depicts a qualitative search/match results from powder X-ray diffraction (XRD) data of the nickel powder collected from the disclosed process, according to some embodiments.

FIG. 11A is a photographic image of the black mass, according to some embodiments.

FIG. 11B is a photographic image of the reduced material, according to some embodiments.

FIG. 11C is a photographic image of the refined nickel powder, according to some embodiments.

FIG. 12 is a graph depicting the weight percent of control and additive materials over time when exposed to the disclosed processes, according to some embodiments.

Other embodiments of the inventions are provided throughout the Application.

### DETAILED DESCRIPTION

Provided herein are various embodiments of a process for recovering elements and compounds from energy storage devices (e.g., lithium ion batteries and spent lithium ion batteries), their electrodes and intermediates (e.g., black mass, fines) of a recycling process. The disclosed chemical processes may aid in overcoming the environmental and cost-effective limitations of prior recycling processes, such as acid extraction processes, prior solventless processes and prior non-effluent generating processes. In certain embodiments, the process may be performed on wet or dry materials. In some embodiments, the process may be used to enrich metal (e.g., nickel cobalt, and/or iron) containing powders by carbonyl processing.

As part of the process, the present disclosure involves a carbonyl refining method, also known as vapometallurgical refining, to recover the valuable elements from spent lithium batteries. This refining technology is based on a chemical reaction where when pure or impure nickel metal contacts carbon monoxide at atmospheric pressure at temperature of 50-60° C., a gaseous compound nickel tetracarbonyl is formed. The reaction is shown below as:

Ni(s)+4 CO(g)→Ni(CO)₄(g)

However, when nickel carbonyl is heated above about 220° C. (e.g., about 220-250° C., about 400-500° C., about 220-900° C.), its decomposition will occur, resulting in nickel metal and carbon monoxide:

Ni(CO)₄(g)→Ni(s)+4 CO(g)
(where “g” and “s” represent “gas” and “solid”, respectively)

Among the materials comprising the rechargeable lithium batteries, and under the disclosed processing conditions, metal elements (e.g., nickel, cobalt and/or iron metals) may form carbonyl compounds, and the formed carbonyl compounds from the different metals have different formation and different volatility properties. Therefore, this carbonyl refining method can be used to extract metals (e.g., nickel, cobalt and iron) from mixtures formed from electrodes, and to separate the individual metals from each other to form individual high-purity metals. In some embodiments, with a specifically designed decomposer, the purified nickel and cobalt elements can be recovered in their powder or solid form during decomposition of the corresponding carbonyl. In some embodiments, modification of decomposer operation or conditions enables distinct powder morphologies and types to be recovered.

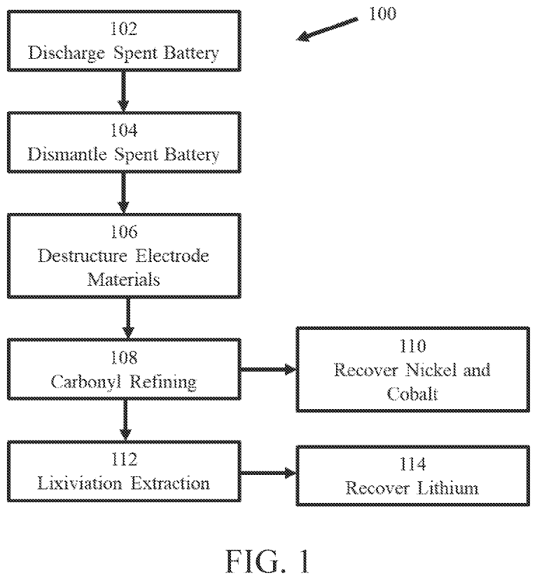

The entire process of the present disclosure preferably includes the major steps of discharging the spent rechargeable lithium batteries in an aqueous solution; dismantling the batteries and separating battery components; reducing the collected cathode electrode materials together with anode electrode materials; and recovering valuable nickel and cobalt using carbonyl technology and lithium by water lixiviation method. For example, FIG. 1 shows a process 100 for recovering elements from a spent battery, according to one embodiment. The process 100 begins with discharging 102 the spent battery. In some embodiments, discharging may be performed in an aqueous solution (e.g., saline solution). The discharged battery is then dismantled 104 in order to separate various battery components from the electrode materials. For example, the electrodes (e.g., anode and cathode) may be separated to isolate electrode materials (e.g., electrode film) from the electrode foil. The electrode material is then destructured 106 (e.g., crushed and/or reduced in size) and the destructured electrode materials are collected. In some embodiments, the cathode and anode electrode materials are destructured and collected together. A carbonyl refining process 108 is performed on the destructured electrode material to recover nickel and cobalt 110, and a lixiviation extraction 112 (e.g., water lixiviation method or acid lixiviation) is performed to recover lithium 114.

In some embodiments, the recovered nickel and cobalt are in their metallic form (e.g. powder). In some embodiments, the recovered lithium is in a hydroxide form or a carbonate form. Such hydroxide, carbonate and/or metallic materials may be used as raw materials directly to produce lithium battery cathode materials using the disclosed process, which does not generate effluent. In some embodiments, such recovered metals can also be applied to other industries, such as powder metallurgy.

As discussed, the spent rechargeable lithium batteries are preferably discharged by an aqueous solution (e.g., saline solution) to mitigate the potential risk of short circuiting or battery blast. In some embodiments, the solution can be an aqueous solution with a conductivity of, of about, of at least, or of at least about, 800 mS/m, 1000 mS/m, 1500 mS/m, 2000 mS/m, 2500 mS/m, 3000 mS/m, 3500 mS/m, 4000 mS/m, 45000 mS/m, 5000 mS/m, 6000 mS/m, 8000 mS/m or 10000 mS/m, or any range of values therebetween. In some embodiments, the aqueous solution includes Na₂SO₄, NaCl or combinations thereof.

After discharge, the spent rechargeable lithium batteries are dismantled mechanically to remove the housing. After removal of the housing, the electrodes are destructured (e.g., crushed or shredded) to form particles. In some embodiments, the destructured particles have an average particle size of, of about, of at most, or of at most about, 0.1 mm, 0.5 mm, 0.8 mm, 1 mm, 2 mm, 3 mm, 4 mm, 5 mm, 6 mm, 8 mm or 10 mm, or any range of values therebetween. In some embodiments, a solvent (e.g., an organic solvent) may be used to wash the destructured particles. In some embodiments, washing aids in detaching the electrode active material from the current collector and to remove the electrode binder material (e.g., polyvinylidene fluoride (PVDF)). In some embodiments, the solvent includes N-methyl-2-pyrrolidone (NMP), N,N-dimethylformamide, N,N-dimethylacetamide, or combinations thereof. In some embodiments, a filtration process may be applied to separate the solvent from the destructured electrode materials (i.e., electrode active materials and current collectors). The solvent may be reused after removing the binder, by evaporation of the solvent. In some embodiments, the mixture of the electrode active materials (i.e., anode active material and cathode active materials (e.g., transition metal oxides)) is then obtained with a screening operation to remove the current collector materials, binder and/or battery electrolyte, and form an electrode active material mixture. The electrode active material mixture may contain lithium salts, transition metal oxides (e.g., nickel, cobalt and lithium oxides), carbon materials (e.g., graphite, active carbon) and other organic and/or inorganic impurities.

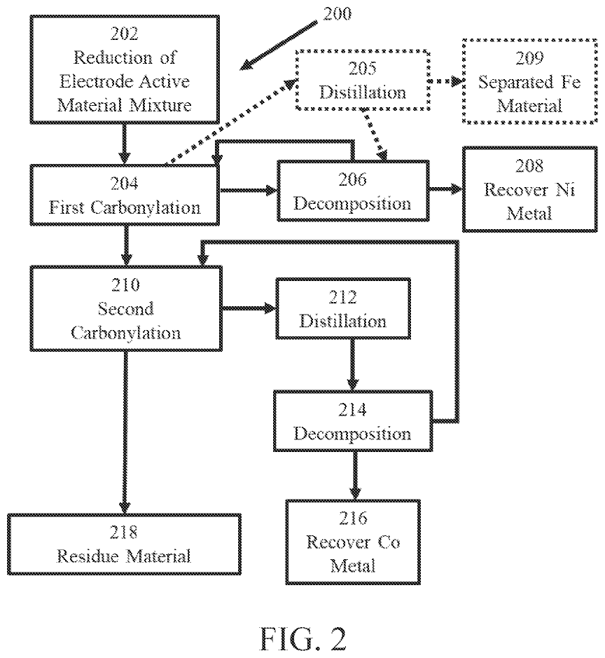

Once the electrode active material mixture is obtained, a carbonyl process is performed to recover nickel and cobalt in their metallic forms. For example, FIG. 2 shows a carbonyl refining process 200 for recovering metallic nickel and cobalt from the electrode active material mixture. The electrode active material mixture is reduced 202, a first carbonylation 204 is subsequently performed. A decomposition 206 is performed on first carbonylated material to obtain recovered nickel metal 208, wherein the first carbonylation 204 and decomposition 206 may be repeated to obtain additional recovered nickel metal 208. In some embodiments, an optional distillation 205 is performed subsequent to the first carbonylation 204 and prior to the decomposition 206 to separate the nickel material (e.g., nickel carbonyl) from the iron material (e.g., iron carbonyl) 209. The optional distillation 205 may be performed if the feedstock material comprises Fe or a substantial amount of Fe. In some embodiments, the optional distillation 205 is not performed when the feedstock material does not (or does not substantially) include Fe, includes a negligible amount of Fe, or a minimal amount of Fe. A decomposition may be performed on the isolated iron material 209 to obtain recovered iron metal. A second carbonylation 210 is performed on the remaining first carbonylated material absent the recovered nickel metal. A distillation 212 and subsequent decomposition 214 is performed on the second carbonylated material to obtain recovered cobalt metal 216, wherein the second carbonylation 210, distillation 212 and decomposition 214 may be repeated to obtain additional recovered cobalt metal 216. Residue material 218 remains after the carbonyl refining process 200 is performed, and includes lithium and carbon material (e.g., graphite, active carbon).

In some embodiments, reduction of the electrode active material mixture is performed using hydrogen, carbonaceous materials, hydrocarbon materials (e.g., coke, pitch, or combinations thereof), a partially reformed gaseous form thereof, and combinations thereof. In some embodiments, reduction is performed in a reducing atmosphere. In some embodiments, the reducing atmosphere comprises hydrogen gas. In some embodiments, the carbon-containing materials remaining in the electrode active material mixture (e.g., active carbon and graphite) are utilized as reducing agents. In some embodiments, the reduction process is performed under mild conditions, such that the carbon-containing materials are not, are not substantially, or are not completely consumed during the reduction process.

In some embodiments, reduction is performed at a temperature of, of about, of at least, or of at least about, 200° C., 250° C., 300° C., 350° C., 400° C., 450° C., 500° C., 550° C., 600° C., 650° C., 700° C., 800° C., 900° C., 1000° C., 1100° C., 1200° C., 1300° C., 1500° C. or 1800° C., or any range of values therebetween. For example, in some embodiments the range of reduction temperature is 300 to 1200° C., 450 to 600° C., or between 500-1000° C. In some embodiments, the atmosphere during the reduction includes nitrogen, hydrogen, carbon monoxide, or combinations thereof. In some embodiments, the reduction atmosphere contains nitrogen and hydrogen, or carbon monoxide and hydrogen.

Example mechanisms of the reduction reactions are the following:

4LiNiO₂+3C→2Li₂O+3CO₂+4Ni, 4LiCoO₂+3C→2Li₂O+3CO₂+4Co

and/or

2LiNiO₂+3H₂→Li₂O+3MH₂O+2Ni, 2LiCoO₂→Li₂O+3H₂O+2Co

and/or

2LiNiO₂+3CO→Li₂O+3CO₂+2Ni, 2LiCoO₂+3CO→Li₂O+3CO₂+2Co

and/or

2Li(M)O₂+3H₂→Li₂O+3H₂O+2M

In some embodiments, “M” in the lithium mixed-metal dioxide (i.e., 2Li(M)O₂) shown in the mechanism above comprises a metal element. In some embodiments, the metal element includes Ni, Co, Fe, Mn, Al, Zr, Ca, or combinations thereof. For example, some embodiments M includes at least Ni, Co and/or Fe. In some embodiments, M includes, includes about, includes at least, or includes at least about, 0.1 mol %, 0.5 mol %, 1 mol %, 5 mol %, 10 mol %, 20 mol %, 30 mol %, 40 mol %, 50 mol %, 60 mol %, 70 mol %, 80 mol %, 90 mol %, 95 mol % or 100 mol %, or any range of values therebetween, of each metal element M independently comprises. For example, in some embodiments 2Li(M)O₂ may be Li(NiₓMn_{y}Co_{z})O₂, Li (Niₓ)O₂, or Li(NiₓMn_{z}Al_{z}), wherein x, y and z represent different mol %'s each metal element is present in M. In such embodiments, the reducing step involves chemical reactions of nickel and cobalt from a valence from +3 to a valence 0. In some embodiments, the resultant from the reduction of a lithium mixed-metal dioxide may contain individual metals (e.g., “M”; such as nickel, iron and/or cobalt), metal alloys, and/or metal oxide phases of individual metals or metal alloys (e.g., nickel, cobalt, iron, manganese, aluminum, zirconium and/or calcium). In some embodiments, the reduction conditions are configured to maximize the amount of nickel and cobalt produced in metallic form.

Once the reduction is complete, the reduced mixture is transferred to a carbonylation reactor (e.g. first or second carbonylation reactor) under inert conditions (e.g., helium, nitrogen, and/or argon gas). In some embodiments, the first and second carbonylation reactors are the same or different reactors. In some embodiments, the reduced mixture is maintained at temperature of, of about, of at most, or of at most about, 20° C., 25° C., 30° C., 40° C., 50° C., 55° C., 60° C., 70° C. or 80° C., or any range of values therebetween. The first carbonylation process is performed by passing carbon monoxide gas through the reduced mixture to produce gaseous nickel carbonyl. In some embodiments, the first carbonylation is performed at a pressure of, of about, of at least, or of at least about, 14 PSIG, 15 PSIG, 20 PSIG, 50 PSIG, 100 PSIG, 150 PSIG, 200 PSIG, 250 PSIG, 300 PSIG, 400 PSIG, 500 PSIG, 600 PSIG, 700 PSIG, 800 PSIG, 900 PSIG, 1000 PSIG, 1100 PSIG, 1200 PSIG, 1300 PSIG, 1500 PSIG, 1800 PSIG, 2000 PSIG, 2200 PSIG, 2500 PSIG, 3000 PSIG, 3500 PSIG or 4000 PSIG, or any range of values therebetween. In some embodiments, the first carbonylation is performed at a temperature of, of about, of at most, or of at most about, 20° C., 30° C., 40° C., 50° C., 60° C., 70° C., 80° C., 90° C., 100° C., 120° C., 140° C., 150° C., 180° C. or 200° C., or any range of values therebetween. For example, in some embodiments the first carbonylation is performed at a pressure of 800-2000 PSIG and 80-150° C.

At the completion of the first carbonylation step, nickel, iron and cobalt will have been partially, substantially or completely converted to binary metal carbonyls. Nickel carbonyl and iron carbonyl, if present, are in their gaseous forms and are removed from the remaining solid mixture in the carbonylation vessel. Cobalt carbonyl, Co₂(CO)₈, formed in the process is, however, in solid form because of its low volatility under such conditions. The separated nickel carbonyl and/or iron carbonyl can be heated and decomposed in a decomposition chamber to form pure metallic nickel and/or iron and carbon monoxide. In some embodiments, if sufficient quantities of iron carbonyl are present, Ni(CO)₄ and Fe(CO)₅ may be separated (e.g., by distillation) prior to decomposition. In some embodiments, the nickel carbonyl is heated to form nickel metal at a temperature of, of about, of at least, or of at least about, 200° C., 220° C., 250° C., 300° C., 350° C., 400° C., 450° C., 500° C., 600° C., 700° C., 800° C., 900° C., 1000° C. or 1200° C., or any range of values therebetween. In some embodiments, the iron carbonyl is heated to form iron metal at a temperature of, of about, of at least, or of at least about, 200° C., 220° C., 250° C., 300° C., 350° C., 400° C., 450° C., 500° C., 600° C., 700° C., 800° C., 900° C., 1000° C. or 1200° C., or any range of values therebetween.

After the nickel and iron content have been removed by carbonylation, the cobalt carbonyl (i.e., Co₂(CO)₈) is converted into a volatile metal carbonyl in a second carbonylation process. In some embodiments, the second carbonylation is performed at a pressure of, of about, of at least, or of at least about, 14 PSIG, 15 PSIG, 20 PSIG, 50 PSIG, 100 PSIG, 150 PSIG, 200 PSIG, 250 PSIG, 300 PSIG, 400 PSIG, 500 PSIG, 600 PSIG, 700 PSIG, 800 PSIG, 900 PSIG, 1000 PSIG, 1100 PSIG, 1200 PSIG, 1300 PSIG, 1500 PSIG, 1800 PSIG, 2000 PSIG, 2200 PSIG, 2500 PSIG, 3000 PSIG, 3500 PSIG or 4000 PSIG, or any range of values therebetween. In some embodiments, the second carbonylation is performed at a temperature of, of about, of at most, or of at most about, 20° C., 30° C., 40° C., 50° C., 60° C., 70° C., 80° C., 90° C., 100° C., 120° C., 140° C., 150° C., 180° C. or 200° C., or any range of values therebetween. For example, in some embodiments the second carbonylation is performed at about 2500 PSIG and about 40-120° C. (e.g., 90° C.).

In some embodiments, the second carbonylation process may be performed by a first method of: 1) a gaseous mixture of nitrogen monoxide and carbon monoxide is introduced to the remaining first carbonylation mixture, wherein the Co₂(CO)₈ is transformed to volatile and decomposable cobalt nitrosyl tricarbonyl via the chemical reaction as shown below:

Co₂(CO)₈+NO→CoNO(CO)₃+CO

In some embodiments, the second carbonylation process may be performed by a second method of: 2) a gaseous mixture 1:1 (v/v) of H₂ and carbon monoxide (i.e., syngas) may be introduced into the reactor. At pressures of, of about, of at least, or of at least about, 14 PSIG, 15 PSIG, 20 PSIG, 50 PSIG, 100 PSIG, 150 PSIG, 200 PSIG, 250 PSIG, 300 PSIG, 400 PSIG, 500 PSIG, 600 PSIG, 700 PSIG, 800 PSIG, 900 PSIG, 1000 PSIG, 1100 PSIG, 1200 PSIG, 1300 PSIG, 1500 PSIG, 1800 PSIG, 2000 PSIG, 2200 PSIG, 2500 PSIG or 3000 PSIG, or any range of values therebetween, the syngas, cobalt metal, cobalt salts and Co₂(CO)₈ react to form cobalt tetracarbonyl hydride (i.e., HCo(CO)₄). This cobalt tetracarbonyl hydride compound exhibits high volatility and readily decomposes to cobalt metal in the absence of carbon monoxide.

By distillation the volatile cobalt carbonyl (e.g., cobalt nitrosyl tricarbonyl and/or cobalt tetracarbonyl hydride) can be separated from the solid mixture. In some embodiments, the second carbonylation process may be avoided or bypassed, and instead Co₂(CO)₈ is separated from the first carbonylation residue by sublimation under mild vacuum. In some embodiments, the second carbonylation favors the formation of Co₂(CO)₈, such that produced cobalt carbonyl includes Co₂(CO)₅ in, in about, in at least, or in at least about, 50 wt. %, 60 wt. %, 70 wt. %, 80 wt. %, 90 wt. %, 92 wt. %, 95 wt. %, 98 wt. % or 99 wt. %, or any range of values therebetween.

The isolated cobalt carbonyl (e.g., Co₂(CO)₈, CoNO(CO)₃, and/or HCo(CO)₄) may be decomposed to pure metallic cobalt and a gaseous mixture (e.g., NO and/or CO). In some embodiments, the off gas during decomposition can be recycled to the front process streams. In some embodiments, the carbonyl processes (e.g., first and second carbonylation) can be operated under closed-loop conditions (i.e., the introduced gases, such as carbon monoxide and nitrogen monoxide, are collected and reused in the process, without generating any gaseous or liquid effluent). In some embodiments, the cobalt carbonyl is heated to form cobalt metal at a temperature of, of about, of at least, or of at least about, 200° C., 220° C., 250° C., 300° C., 350° C., 400° C., 450° C., 500° C., 600° C., 700° C., 800° C., 900° C., 1000° C. or 1200° C., or any range of values therebetween.

In some embodiments, the realized rates and/or extraction efficiencies of the carbonylation reactions may be enhanced by the use of an additive. In some embodiments, an additive may be introduced immediately prior or during reduction step, carbonylation (e.g., first and/or second carbonylation) step, or combinations thereof. In some embodiments, the additive is an elemental compound, a salt, a molecular compound, or combinations thereof. In some embodiments, the molecular compound is a chalcogenide (e.g., sulfur or tellurium material), Cl₂, or combinations thereof. In some embodiments, the salt is a chloride salt. In some embodiments, a chloride salt may be added to the feed material. In some embodiments, the additive is added to the feed material in, in about, in at least, or in at least about, 0.05 wt. %, 0.1 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 12 wt. % or 15 wt. % relative to the feed material weight. In some embodiments, the chloride salt includes LiCl, NaCl, KCl, CaCl₂), MgCl₂, or combinations thereof. While not being bound by theory, these salts may facilitate reduction by in situ formation of HCl at elevated temperatures and hydrogen pressures, wherein the HCl may react to from metal halides which can be more facile to reduce than incumbent oxides. Furthermore, while not being bound by theory, during carbonylation a chalcogenide (e.g., sulfur or tellurium) may function to as effective catalysts.

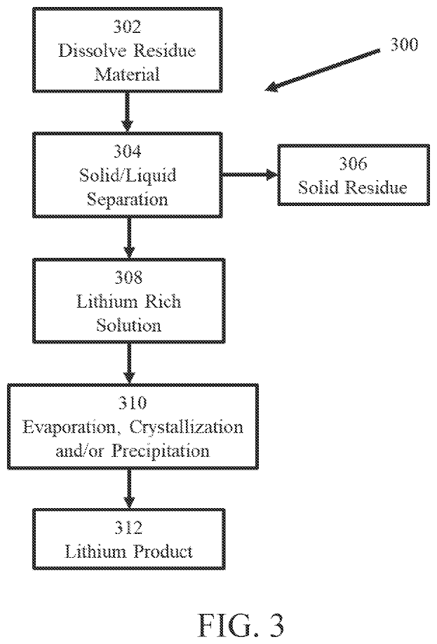

After removal of nickel, iron and/or cobalt, a residue material remains that includes lithium (e.g., in the form of LiO₂, LiOH and/or LiOH*(H₂O)), which is to be extracted by a lixiviation extraction, and a carbon material (e.g., graphite, active carbon). For example, FIG. 3 shows a lixiviation extraction process 300 for recovering lithium from the residue material. The residue material is dissolved 302 to form a slurry, and a solid/liquid separation 304 is performed to isolate undissolved solid residue 306 from a lithium rich solution 308. The evaporation, crystallization and/or precipitation 310 is performed on the lithium rich solution 308 to isolate a lithium product 312.

In some embodiments, water and/or weak acid is introduced into the residue material to dissolve the residue material and form a slurry, wherein the lithium content of the residue material is dissolved in the liquid. In some embodiments, the solid/liquid separation may be performed in a dissolved air flotation unit or a separation tank. In some embodiments, residual anode material (e.g., graphite) may float to the top of the slurry and is isolated by skimming. In some embodiments, residual current collector material (e.g., Cu and Al) may sink to the bottom of the slurry and is collected. In some embodiments, the lithium product includes lithium hydroxide, lithium carbonate, or combinations thereof. In some embodiments, lithium hydroxide is obtained with evaporation/crystallization of the collected lithium-containing solution. In some embodiments, lithium carbonate is generated by a precipitation process by introducing carbon dioxide and/or a carbonate salt to the collected lithium containing solution.

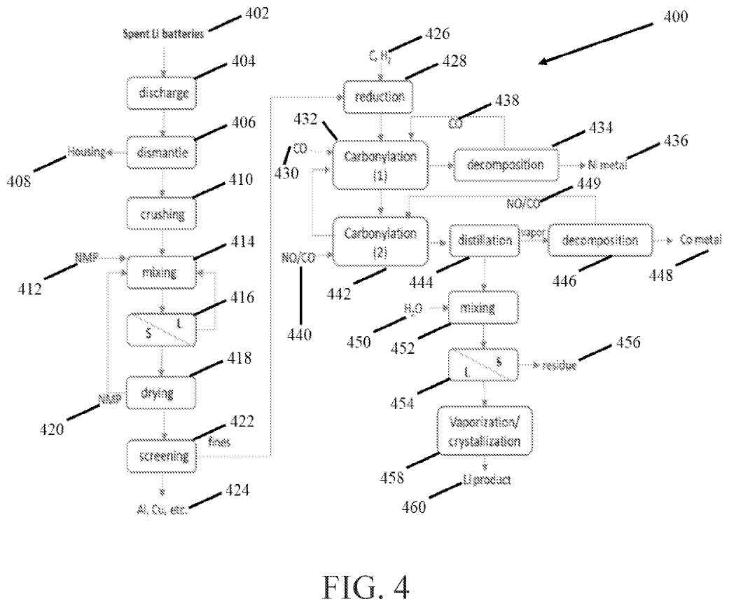

FIG. 4 shown an example of the specific process 400 for recovering nickel, cobalt, and lithium elements from a spent battery from start to finish. A spent lithium battery 402 is provided, discharged 404 and dismantled 406 to remove the housing 408. The electrode material is crushed 410 and N-methyl-2-pyrrolidone (NMP) is added 412 to the crushed electrode material and mixed 414 to form a slurry. A solid/liquid separation 416 is performed on the slurry and may be repeated. The separated solid material is dried 418, with the NMP solvent returned 420 and reused in mixing step 414, and the dried solid material is screened 422 to separated the current collector materials 424 such at Al, Cu, etc. from the electrode active materials. The electrode active material in this example does not include Fe, or includes a negligible and/or minimum amount of Fe. The electrode active material is combined with a carbon source (C) and/or a hydrogen source (H₂) 426 and a reduction 428 is performed. The reduced material is combined with carbon monoxide (CO) 430 and a first carbonylation 432 is performed followed by a decomposition 434 to produce nickel (Ni) metal 434. As the electrode active material feedstock did not include Fe or included negligible/minimal Fe, a distillation was not required to separate the Ni carbonyl from the Fe carbonyl before decomposition 434. The decomposed carbon monoxide 438 may be reused in the first carbonylation 432. The remaining first carbonylated material is combined with nitrogen monoxide (NO) and/or carbon monoxide (CO) 440 and a second carbonylation 442 is performed, followed by a distillation 444 and decomposition 446 of the distilled vapor to produce cobalt (Co) metal 448. The decomposed nitrogen monoxide and/or carbon monoxide 449 may be reused in the second carbonylation 442. The residue material left from the distillation 444 is combined with water (H₂O) 450 and mixed 452 to form a slurry, a solid liquid separation 454 is performed on the slurry, and undissolved solid residue 456 is removed from the lithium rich solution. Vaporization and/or crystallization 458 is performed on the lithium rich solution and a lithium product 460 is produced.

### EXAMPLES

Example embodiments of the present disclosure, including processes, materials and/or resultant products, are described in the following examples.

### General Methods and Instrumentation

All manipulations were conducted using standard laboratory processing techniques. Reduced materials were handled in a nitrogen filled glovebox or with standard inert handling techniques. All gases utilized (e.g., H₂, CO, Ar, N₂) were high-purity, equivalent or better.

Powder X-ray diffraction analysis was performed on a Bruker D₈ Advance powder X-ray diffractometer equipped with a sealed-tube copper radiation source, vertical goniometer, and LYNXEYE XE-T detector with 0/90° mount. Phase analysis was performed either with Bruker Diffrac EVA software or Crystal impact Match! Software. Scanning electron microscopy was performed on a JEOL JSM-IT500HR/LA microscope. Particle size analyses were performed using ASTM certified test sieves or by laser diffraction on a Malvern Panalytical Mastersizer 3000 equipped with wet and dry measurement cells. Elemental analysis was performed using inductively coupled plasma optical emission spectroscopy (ICP-OES) on an Agilent series 5900 spectrometer. The surface area of materials was measured gas adsorption using the Brunauer-Emmett-Teller (BET) surface analysis method. Measurements were performed on using a Micrometrics Tristar II Plus 3030 surface area and porosity analyzer.

Reduction Furnace Description

Reduction studies were conducted in single-zone, static tube furnace equipped with a 100 mm diameter quartz tube and hydrogen gas supply (Across International STF1200 series). The system is installed in a custom configured glovebox so as to enable handling of the reduced solids in absentia oxygen or water. Black mass was loaded into alumina crucibles and brought to a specified temperature at a specified ramp-rate. Hydrogen gas was allowed to flow through the tube at a specified flowrate and the sample was held at temperature for a specified dwell time. Following reduction, the material was allowed to cool to ambient temperature (18-25° C.) where it was then collected under an inert-atmosphere and stored for later use or analysis.

Carbonylation Unit Description

Carbonylation studies were performed in a customized autoclave (Parr Instrument Company series 4540 Horizontal/Vertical reactor; 600 mL) configured with a vessel MAWP rating of 5000 PSI at 500° C. The unit is equipped with a footless stirrer designed for solids agitation/fluidization, gas manifold for argon, carbon monoxide or alternate gas delivery and an HMI for process monitoring and data collection. The custom unit may be operated in batch, constant-pressure or with continuous gas flushing using a mass flow controller and back pressure regulator. Solid-powder or slurry (50-500 g) was introduced into the reactor under an argon flush to exclude air and moisture. The reactor was then sealed, and pressure tested under an inert atmosphere for 1 h at 20-25° C. The reactor was then brought to target temperature (typically, 100-150° C.) and allowed to stabilize (0.5-1 h). Carbon monoxide gas was then introduced into the reactor. The reactor was operated in constant pressure mode to provide makeup gas supply. Following the specified reaction time, the carbon monoxide supply to reactor was shut-off. Using needle control valves and pressure regulators, the carbonyl gas was then sent to the powder decomposer system.

Powder Decomposer System Description

The powder decomposer system constitutes two (2) hot-wall decomposers connected in series with powder collection bins. The unit functions by injecting a stream of metal carbonyl vapor (Ni, Co or Fe) vertically downward. The carbonyl stream may be pure or mixed with one or more carrier gases (e.g., CO, N₂, Ar) or additives (e.g., NH₃, O₂ etc.). This vapor stream passes from the nozzle into vertically oriented heated cylinder (1″ø×18″). The exterior of the cylinder is resistively heated and insulated by fiberglass. Temperatures in the heated section are monitored by thermocouple. The system is cable of reaching stable temperatures up to 500° C. As the vapor stream exiting the nozzle passes through the heated section, metal carbonyls dissociated to produce metal powders and carbon monoxide. The metal powder was isolated in collection bins located below the heated section. Powder morphology may be varied by controlling the nozzle velocity, carrier gas composition and decomposer temperature.

### Example 1: Recycled Battery and Black Mass

The black mass was produced from lithium-ion battery packs (2170 cells, NMC-cathode). The cells were discharged, shredded, and washed. During washing, the intermediate material was size classified to produce “black mass” or “fines”. The effect of these processing steps is to afford a slurry or flowable powder (if dried) that is, primarily, free of the battery casing, electrolyte, separator film, and current collectors (i.e., copper and aluminum). This “black mass” is thus comprised of lithium, cathode (e.g., lithium metal oxides), and anode (e.g., graphite and activated carbons) and constitutes the crude residue required for further enrichment.

Representative physical and chemical properties of this material are provided in Table 1 characterized by optical microscopy, BET surface area, ICP-OES and tap density.

TABLE 1
Representative chemical and physical properties of
black mass material

| | |
|---|---|
| BET (m²/g) | 33 |
| Tap Density (g/cc) | 1.3 |
| Bulk Density (g/cc) | 1.1 |
| Angle of Repose | 29 |
| D10 (μm) | 6.7 |
| D50 (μm) | 20 |
| D90 (μm) | 49 |
| Span (μm) | 2.1 |
| Ni (wt. %) | 26 |
| Fe (wt. %) | 1.8 |
| Co (wt. %) | 1.2 |
| Al (wt. %) | 2.9 |
| Li (wt. %) | 2.9 |
| Cu (wt. %) | 5.5 |

Small-scale samples of black mass (i.e., fines) were hydrogenated and then carbonylated in a thermogravimetric analyzer capable of high-pressure/temperature operation (TA Instruments HP75). This enables the unit to function as a miniaturized reduction furnace and carbonylation reactor. A sample of black mass or mineralogical intermediate (50-100 mg) was placed into a crucible and then sealed into the reaction chamber. The material was then subjected to a specified sequence of reduction and carbonylation conditions using hydrogen and carbon monoxide gas, respectively. Gas pressure and flow rate are controlled using instrument-integrated control. Hydrogenation conditions may range from 0-1000 PSIG H₂ at 20-1000° C. with a flow rate of 0-90 mL/min. Carbonylation conditions may range from 0-1000 PSIG with temperatures between 20-200° C. During unit operation, the magnetic levitating balance equipped on the instrument allows changes in mass and thus metal extraction efficiency to be measured and calculated. The exhaust of the instrument was connected to a sampling line so that the gas-composition of the effluent gases could be monitored by mass spectrometer. This was performed using a Hidden Analytical real time gas analyzer (RTGA) series HPR-20 for detection and quantification of metal carbonyls (e.g., Ni(CO)₄ and Fe(CO)₈).

### Example 2 (Control): Sequential Hydrosgenation/Carbonylation of Nickel Powder

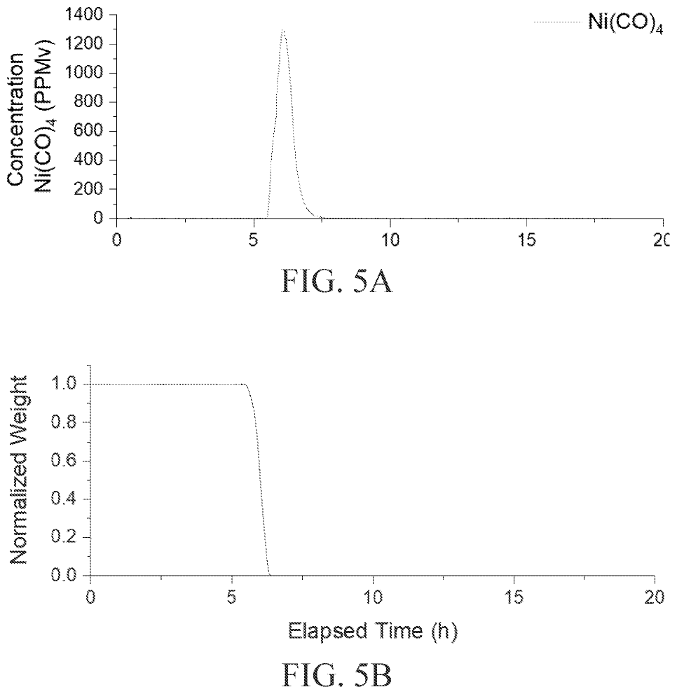

Thermogravimetric analyzer (TGA) studies were performed on commercial nickel powder (Vale grade 123) as a control and on black mass. Nickel powder (Vale 123, 10 μm D₅₀) was loaded into a ceramic (alumina) crucible, placed within the instrument and sealed. The sample was allowed to equilibrate at (50° C.) under a nitrogen purge (100 mL/min) for 5 min. The powder was then reduced under a hydrogen atmosphere (50 PSIG, 90 mL/min H₂, 10 mL/min N₂) for 4 h at 800° C. The sample was then cooled to 100° C. flushed with nitrogen for 5 min then heated to 150° C. under a atmosphere of carbon monoxide (800 or 150 PSIG, 90 mL/min CO; 10 mL/min N₂). During this time, the thermogravimetric analyzer (TGA) was used to monitor weight loss (corresponding to vaporized nickel) in the sample. Concurrently, the exhaust of the TGA instrument was monitored using a real-time gas analyzer to confirm that Ni(CO)₄ evolution occurred concurrently with mass loss. The TGA plots shown in FIGS. 5A and 5B (concentration and normalized weight, respectively) confirm that the evolution of Ni(CO)₄ is concurrent with sample mass loss, and as such yield was calculated from the expected weight loss derived from the elemental composition of the sample. Table 2 summarizes carbonylation results on nickel powder control.

TABLE 2

| Entry | 1 | 2 | 3 |
|---|---|---|---|
| Initial Mass (mg) | 82 | 89 | 77 |
| Final Mass (mg) | 0 | 0 | 0.06 |
| Hydrogenation Pressure (PSIG) | 50 | 50 | 50 |
| Hydrogenation Temperature (° C.) | 800 | 800 | 800 |
| Hydrogenation Duration (h) | 2 | 2 | 2 |
| Mass Loss During Hydrogenation | 0 | 0 | 0.03 |
| (wt. %) | | | |
| Carbonylation Pressure (PSIG) | 800 | 800 | 150 |
| Carbonylation Temperature (° C.) | 150 | 150 | 150 |
| Carbonylation Duration (h) | 12 | 12 | 12 |
| Mass Loss During Carbonylation (%) | 100 | 100 | 99.9 |
| Ni content in feed (wt. %) | >98.6 | >98.6 | >98.6 |
| Extractable Ni (mg) | >80 | >87 | >75 |
| Total Yield Extractable Metal (%) | >99.9 | >99.9 | >99.9 |

### Example 3: Sequential Hydrogenation/Carbonylation of Black Mass

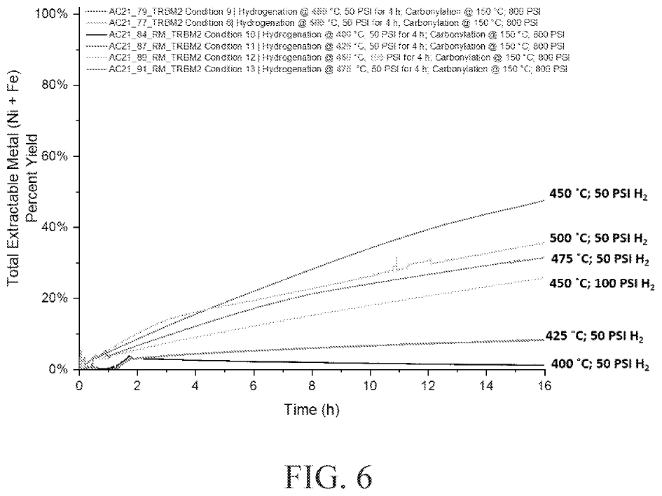

The black mass (i.e., fines) obtained from bulk processing of spent lithium-ion batteries as described in Example 1 was dried at 150° C. for 4 h in air to remove moisture and afford a heterogeneous, black flowable powder. On average, the material was 83 wt. % (+/−7 wt. %) sub-140 Mesh (<106 μm). Optical microscopy and SEM imaging confirmed that oversize materials were predominantly residual aluminum and copper conductors. This material was subjected to a series of sequential hydrogenation/carbonylation experiments under varying conditions, and the results of these experiments are shown in Table 3 and FIG. 6, where T=0 is defined as the start of the carbonylation portion of the sequential hydrogenation/carbonylation experiments. Percent yield of total extractable metal was calculated based on the average content (wt. %) of Ni and Fe in the feedstock. Calculated extraction efficiencies up to 46 wt. % were realized in small-scale tests.

TABLE 3

| Entry | 3 | 4 | 5 | 6 | 7 | 8 |
|---|---|---|---|---|---|---|
| Initial Mass (mg) | 41 | 59 | 74 | 79 | 59 | 92 |
| Final Mass (mg) | 29 | 37 | 59 | 58 | 42 | 6 |
| H2 Pressure (PSIG) | 50 | 50 | 50 | 50 | 100 | 50 |
| Temperature (° C.) | 500 | 450 | 400 | 425 | 425 | 450 |
| Duration (h) | 4 | 4 | 5 | 5 | 4 | 4 |
| Mass Loss During | 20 | 24 | 21 | 24 | 22 | 20 |
| Hydrogenation (%) | | | | | | |
| CO Pressure (PSIG) | 800 | 800 | 800 | 800 | 800 | 800 |
| Temperature (° C.) | 150 | 150 | 150 | 150 | 150 | 150 |
| Duration (h) | 16 | 16 | 19 | 19 | 16 | 16 |
| Mass Loss During | 11 | 13 | 0.3 | 2 | 8 | 8 |
| Carbonylation (%) | | | | | | |
| Feed Ni wt. (%) | 27 | 27 | 27 | 27 | 27 | 27 |
| Feed Fe wt. (%) | 1.4 | 1.4 | 1.4 | 1.4 | 1.4 | 1.4 |
| Total Yield Extractable | 37 | 46 | 1 | 8 | 26 | 28 |
| Metal (%) | | | | | | |

### Example 4: Dried Mass Tube Furnace Reduction

Dried Black mass (i.e., fines) obtained from the processing of spent lithium-ion batteries of Example 1 was pre-dried at 150° C. for 4-12 h in a muffle furnace in air to remove residual moisture from bulk washing and dewatering. On average, the moisture content in the black mass is approximately 40 wt. %. The material was then subjected to reduction under varying temperatures, where Table 4 shows reaction conditions and yields. In the reduction experiment summarized in Table 4, the black mass sample of the specified quantity was loaded into alumina crucibles (˜25 g per crucible) and placed into the tube furnace. The furnace ramp rate, target temperature and dwell timed were programmed and run initiated. Gas flow was adjusted using a calibrated rotameter. At the end of the specified dwell time, the furnace was turned off and allowed to cool to room temperature. Once at room temperature, the process gas supply was halted, and the samples removed under an inert atmosphere.

TABLE 4

| | | | | | | | Process | | Percent |
|---|---|---|---|---|---|---|---|---|---|
| | Initial | Final | | | Set | | Gas Flow | Mass | Mass |
| | Mass | Mass | Process | Ramp | Temp | Dwell | Rate | Change | Loss |
| Entry | (kg) | (kg) | Gas | (° C./hour) | (° C.) | (h) | (mL/min) | (kg) | (%) |
| 9 | 0.08 | 0.07 | H₂ | 240 | 300 | 4 | 400 | 0.01 | 6 |
| 10 | 0.009 | 0.007 | H₂ | 240 | 400 | 4 | 400 | 0.002 | 22 |
| 11 | 0.1 | 0.09 | H₂ | 240 | 400 | 4 | 400 | 0.01 | 10 |
| 12 | 0.013 | 0.01 | H₂ | 240 | 450 | 4 | 400 | 0.003 | 23 |
| 13 | 0.052 | 0.046 | H₂ | 240 | 500 | 4 | 400 | 0.006 | 12 |
| 14 | 0.09 | 0.08 | H₂ | 240 | 500 | 8 | 400 | 0.01 | 15 |
| 15 | 0.09 | 0.08 | H₂ | 240 | 500 | 4 | 400 | 0.01 | 15 |
| 16 | 0.09 | 0.08 | H₂ | 240 | 500 | 8 | 400 | 0.01 | 16 |
| 17 | 0.09 | 0.08 | H₂ | 240 | 500 | 8 | 400 | 0.01 | 16 |
| 18 | 0.1 | 0.08 | H₂ | 240 | 600 | 4 | 400 | 0.02 | 16 |
| 19 | 0.09 | 0.08 | H₂ | 240 | 700 | 4 | 400 | 0.01 | 17 |
| 20 | 0.09 | 0.07 | H₂ | 240 | 800 | 4 | 400 | 0.02 | 24 |

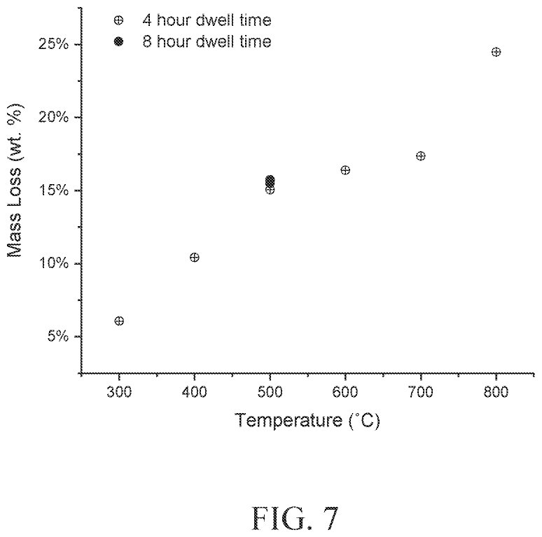

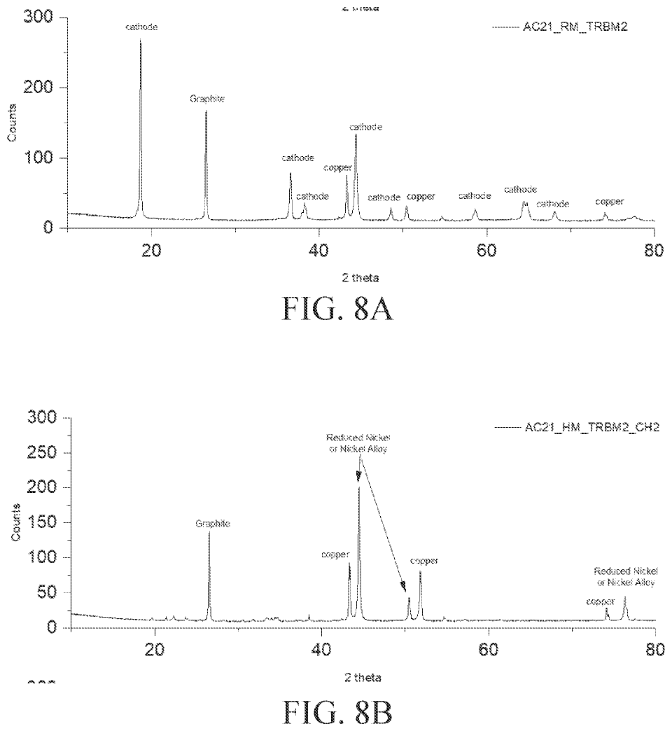

FIG. 7 summarizes weight loss profiles as a function of reduction temperature with varying dwell times (i.e., 4 hours or 8 hours). FIGS. 8A and 8B shows the powder X-ray diffraction (XRD) profiles of Entry 12 before and after, respectively, reduction (450° C., 4 h) confirming the complete reduction of the cathode material and formation of reduced metal.

### Example 5: Wet Mass Tube Furnace Reduction

Wet black mass (i.e., fines) obtained from the processing of spent lithium-ion batteries of Example 1 was reduced directly without pre-drying step. Table 5 summarizes reduction conditions and mass loss. In these experiments, the wet black mass was collected directly from preliminary battery processing steps, loaded into alumina crucibles (˜25 g/crucible), and placed into the tube furnace. The furnace ramp rate, target temperature and dwell timed were programmed and run initiated. Gas flow was adjusted using a calibrated rotameter. At the end of the specified dwell time, the furnace was turned off and allowed to cool to room temperature. Once at room temperature, the process gas supply was halted, and the samples removed under an inert atmosphere.

TABLE 5

| Entry | 21 | 22 |
|---|---|---|
| Initial Mass (kg) | 0.14 | 0.14 |
| Final Mass (kg) | 0.07 | 0.07 |
| Process Gas | H₂ | H₂ |
| Ramp (° C./hour | 240 | 240 |
| Set Temp (° C.) | 500 | 500 |
| Dwell (h) | 8 | 8 |
| Process Gas Flow Rate | 400 | 400 |
| (mL/min) | | |
| Mass Change (kg) | 0.07 | 0.07 |
| Percent Mass Loss (%) | 51% | 50% |

### Example 6: Carbonylation and Powder Production

Reduced dry black mass (70 g), obtained according to Entries 14, 16 or 17 of Example 4, was loaded into the carbonylation reactor under an argon flush. The reactor was sealed, placed into horizontal mode and pressure tested under argon for 1 h at 282 PSIG. The reactor was then heated under argon to 150° C. where the temperature of the reactor was allowed to stabilize. The argon in the reactor was vented to 0 PSIG and then re-pressurized with carbon monoxide to a pressure of 1000 PSTG. The material was allowed to react for 13 h. Thereafter, the reactor was slowly vented by allowing the Ni(CO)₄ rich carbon monoxide vapor to pass through the powder decomposers. For this run, the wall temperature of the powder decomposers was maintained at approximately 350° C. After venting, the reactor and decomposers were flushed with carbon monoxide for 1 h, argon for 10 min and then air. The decomposers and reactor were opened and resulting powders: nickel metal and residue were collected.

In addition, reduced wet black mass (57 g), obtained according to Entries 21 or 22 of Example 5, was loaded into the carbonylation reactor under an argon flush. The reactor was sealed, placed into horizontal mode and pressure tested under argon for 1 h at 200 PSIG. The reactor was then heated under argon to 150° C. where the temperature of the reactor was allowed to stabilize. The argon in the reactor was vented to 0 PSIG and then re-pressurized with carbon monoxide to a pressure of 800 PSIG. The material was allowed to react for 13 h. Thereafter, the reactor was slowly vented by allowing the Ni(CO)₄ rich carbon monoxide vapor to pass through the powder decomposers. For this run, the wall temperature of the powder decomposers was maintained at approximately 350° C. After venting, the reactor and decomposers were flushed with carbon monoxide for 1 h, argon for 10 min and then air. The decomposers and reactor were opened and resulting powders: nickel metal and residue were collected.

Table 6 shows the reaction conditions and yields of the dry black mass (i.e., Entry 23) and wet black mass (i.e., Entry 24) carbonylations.

TABLE 6

| Entry | 23 (Dry) | 24 (Wet) |
|---|---|---|
| Temperature (° C.) | 150 | 150 |
| CO Pressure (psig) | 1000 | 1200 |
| Run Time (h) | 13 | 24 |
| Starting Mass (g) | 70 | 57 |
| Residue Mass (g) | 57 | 43 |
| Ni (wt. %) | 27 | 26 |
| Fe (wt. %) | 1.5 | 4 |
| Theoretical Mass Loss (g) | 20 | 17 |
| Actual Mass Loss (g) | 11 | 14 |
| Extraction Performance | 55 | 83 |
| (% Yield) | | |
| Mass Metal Powder | 3.8 | 4.8 |
| Collected (g) | | |

1) Nickel and iron wt. % determined by ICP-OES analysis of reduced samples. Extraction performance is defined as: (Actual Mass Loss) / (Theoretical Mass Loss) * 100.
2) Theoretical Mass loss is the sum of the nickel and iron content in the starting material and calculated from the starting mass and the Ni and Fe weight % values measured by ICP-OES analysis
3) Mass metal powder was low due to the production of nano-nickel powders which were not captured in powder decomposer trap.

Table 7 shows the physical and chemical properties of the dry black mass (i.e., Entry 23) and wet black mass (i.e., Entry 24) carbonylation materials characterized by optical microscopy, BET surface area, ICP-OES.

TABLE 7
Characterization Data for Product Nickel Powders

| Entry | 23 (Dry) | 24 (Wet) |
|---|---|---|
| BET (m²/g) | 1.8 | 0.6 |
| Powder Morphology | Filamentary | Acicular |
| | (light powder) | (heavy powder) |
| ICP-OES Analysis | | |
| (wt. %): | | |
| Ni | 84% | 90% |
| Fe | 1.7% | 0.3% |
| Balance | Balance from O and C | Balance from O and C |

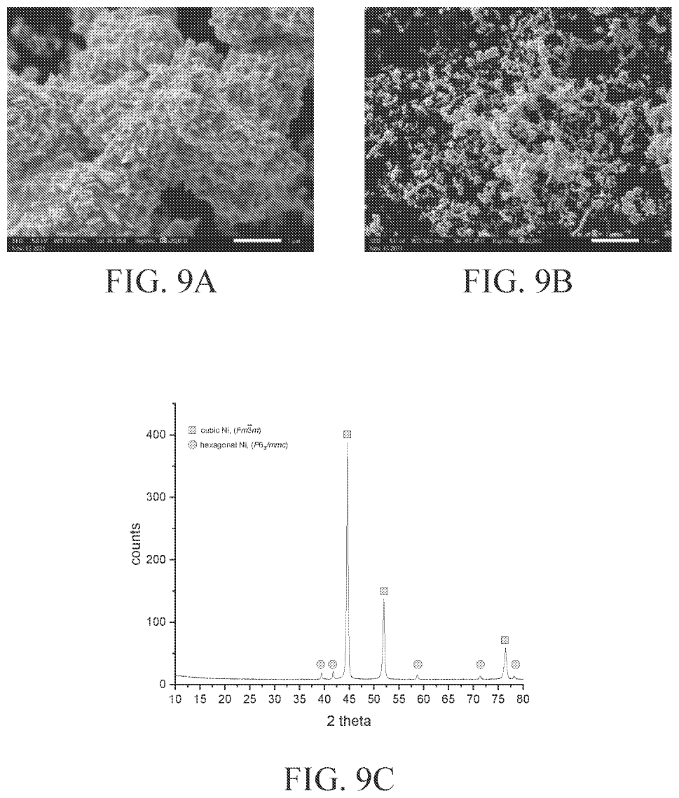

FIGS. 9A and 9B are scanning electron microscopy (SEM) images of the nickel powder collected from Entry 23 (Dry), wherein the powder shows a filamentary morphology. FIG. 9C shows the qualitative search/match results from a XRD data of the nickel powder collected from Entry 23 (Dry), which shows two phases of nickel: a major phase exhibits diffraction peaks consistent with face-centered cubic nickel (Fm-3m); and a minor phase exhibits diffraction peaks consistent with hexagonal nickel (P6₃/mmc).

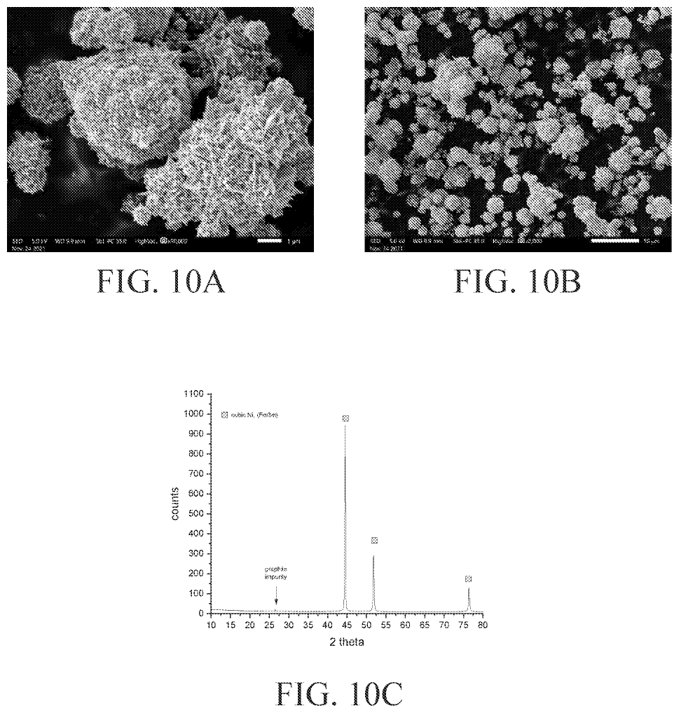

FIGS. 10A and 10B are scanning electron microscopy (SEM) images of the nickel powder collected from Entry 24 (Wet), wherein the powder shows an acicular morphology. FIG. 10C shows the qualitative search/match results from a XRD data of the nickel powder collected from Entry 24 (Wet), which shows a single phase: the major phase exhibits diffraction peaks consistent with face-centered cubic nickel (Fm-3m).

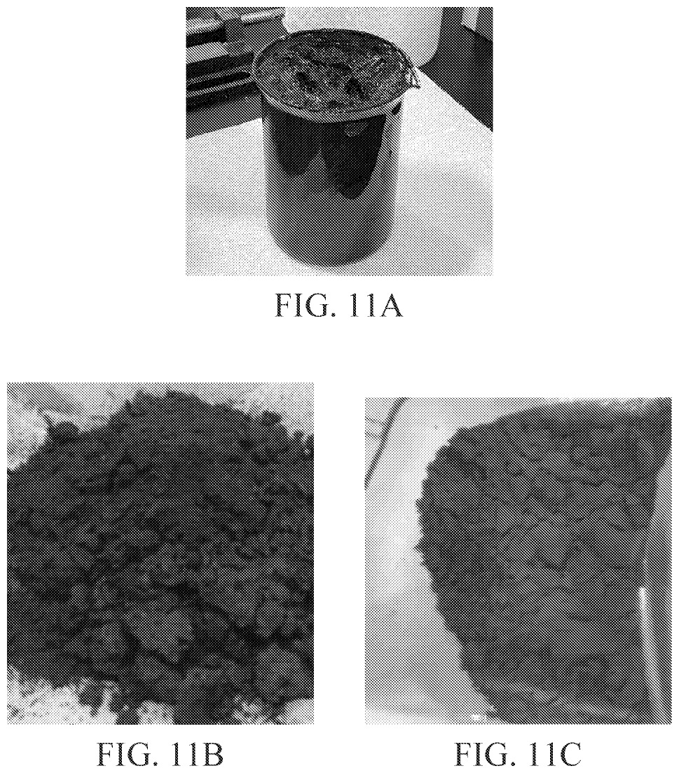

FIGS. 11A-11C are photographic images of the black mass, reduced material and the refined nickel powder isolated from the process, respectively.

### Example 7: Sulfur Additive

Black mass (1.28 kg) obtained from bulk processing of spent lithium-ion batteries as described in Example 1 was dried at 150° C. for 4 h in air to remove moisture and afford a heterogeneous, black flowable powder (0.75 kg, 41.3% mass loss). ICP-OES analysis of this materials showed it to have a nickel content of approx. 26 wt. %. The material was sieved to remove oversize (140 Mesh) material. Oversize was predominantly comprised of aluminum and copper electrode backing missed during bulk processing. The undersized material subjected to carbonyl enrichment process in one of two ways: A control process that did not include additional processing or additional additives, and an additive process that included a sulfur additive and mixed using a planetary milling sequence.

Subsequent to the control process, a sample of the dry, sieved control material (˜50 mg) was placed in the TGA-MS. The material was then subjected to sequential hydrogenation (50 PSI and 450° C. for 5 h) and carbonylation (800 PSI and 150° C. for 19 h) to produce a control final product (i.e., “PRM TRMB3 Dry U106”). Conversion (theoretical weight loss from the extraction of nickel) was found to be <20 wt. % in the control final product.

Subsequent to the additive process, a sample of the dry sieved material (98 g) was combined with 1 wt. % sulfur (0.98 g) and placed into a high intensity planetary mill with ceramic jar and media (alumina). The material was milled for 10 min at 300 rpm. The resulting material was collected, and a sample (˜50 mg) placed in the TGA-MS. The material was then subjected to sequential hydrogenation (50 PSI and 450° C. for 5 h) and carbonylation (800 PSI and 150° C. for 19 h) to form a additive final product (i.e., “PRM TRMB3 Dry+1 wt. % S”). Conversion (theoretical weight loss from the extraction of nickel) was found to be >90 wt. %.

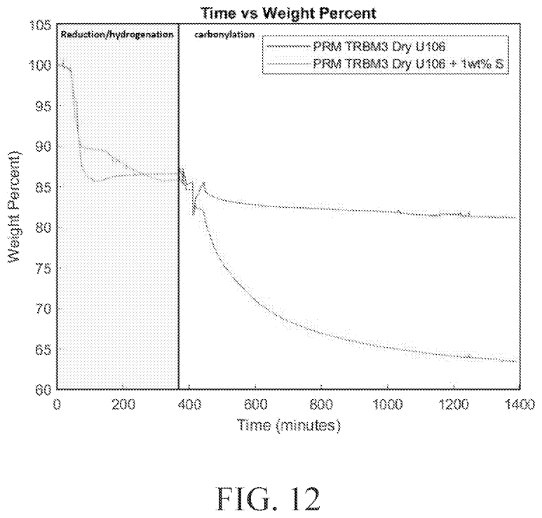

FIG. 12 depicts the weight percent of the control and additive material over time during the reduction and carbonylation steps, and shows that the sulfur additive improves conversion and extraction of nickel.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

1. A process to recover materials from an energy storage device electrode, comprising:
reducing an electrode active material mixture to form a reduced mixture, wherein the electrode active material mixture comprises a nickel oxide, a cobalt oxide, and a lithium material selected from the group consisting of a lithium salt, a lithium oxide and combinations thereof;
performing a first carbonylation and a subsequent first decomposition on the reduced mixture to isolate a nickel product comprising nickel metal form a first carbonylated material; and
performing a second decomposition on the first carbonylated material to isolate a cobalt product comprising cobalt metal form a residue material.

2. The process of claim 1, wherein reducing comprises reacting the electrode active material mixture with a compound selected from the group consisting of hydrogen, a carbonaceous material, a hydrocarbon material, a partially reformed product thereof, and combinations thereof.

3. The process of claim 1, wherein reduction is performed at temperature of about 300-1200° C.

4. The process of claim 1, wherein the first carbonylation comprises reacting the reduced mixture with a gas selected from the group consisting of carbon monoxide, nitrogen monoxide, hydrogen, and combinations thereof.

5. The process of claim 1, wherein the first carbonylation is performed at a temperature of about 40-120° C.

6. The process of claim 1, wherein the first carbonylation is performed at a pressure of about 15-2000 PSIG.

7. The process of claim 1, further comprising distilling the reduced mixture subsequent to the first carbonylation and prior to the first decomposition thereby removing an iron product comprising an iron carbonyl from the reduced mixture.

8. The process of claim 1, further comprising mixing an additive with the reduced mixture.

9. The process of claim 8, wherein the additive is selected from the group consisting of a sulfur material, a tellurium material, Cl₂, LiCl, NaCl, KCl, CaCl₂), MgCl₂, and combinations thereof.

10. The process of claim 8, wherein the additive is mixed with the reduced mixture in about 1-10 wt. % of the reduced mixture.

11. The process of claim 1, further comprising performing a sublimation on the first carbonylated material prior to the second decomposition.

12. The process of claim 1, further comprising performing a second carbonylation on the first carbonylated material prior to the second decomposition.

13. The process of claim 12, wherein the second carbonylation comprises reacting the first carbonylated material with a gas comprising carbon monoxide.

14. The process of claim 12, wherein the second carbonylation is performed at a temperature of about 40-120° C.

15. The process of claim 12, wherein the second carbonylation is performed at a pressure of about 800-2500 PSIG.

16. The process of claim 12, further comprising performing a distillation on the first carbonylated material subsequent to the second carbonylation and prior to the second decomposition.

17. The process of claim 1, further comprising:
discharging an energy storage device in an aqueous solution;
dismantling the discharged energy storage device to isolate the electrode materials; and
destructuring the electrode materials to form the electrode active material mixture.

18. The process of claim 17, wherein the aqueous solution has a conductivity of at least about 1000 mS/m.

19. The process of claim 17, wherein the aqueous solution is a saline solution comprising a salt selected from the group consisting of Na₂SO₄, NaCl, and combinations thereof.

20. The process of claim 17, wherein destructuring forms the electrode active material mixture comprising particles with an average particle size of at most about 5 mm.

21. The process of claim 17, further comprising washing the destructured electrode materials and separating the electrode active material mixture from a current collector material.

22. The process of claim 21, wherein washing comprises applying an organic solvent selected from the group consisting of N-methyl-2-pyrrolidone (NMP), N,N-dimethylformamide, N,N-dimethylacetamide, and combinations thereof.

23. The process of claim 17, wherein the energy storage device is a spent lithium ion battery.

24. The process of claim 1, further comprising performing a lixiviation extraction to isolate a lithium product.

25. The process of claim 24, wherein the lixiviation extraction comprises:
dissolving the residue material in an aqueous solution to form a slurry;
performing a solid/liquid separation on the slurry to isolate a lithium rich solution from a solid reside; and
performing an isolation process on the lithium rich solution to form the lithium product.

26. The process of claim 25, wherein the aqueous solution comprises an acid.

27. The process of claim 24, wherein the lithium product is selected from the group consisting of lithium hydroxide, lithium carbonate, and combinations thereof.
